(19) United States
(12) Patent Application Publication
(10) Pub. No.: US 2007/0047863 A1
(43) Pub. Date: Mar. 1, 2007

(54) Bearing apparatus for driving wheel and working method thereof

(75) Inventors: Masahiro Yasumura, Kanagawa-ken (JP); Shoji Horike, Kanagawa-ken (JP)

Correspondence Address: CROWELL & MORING LLP;INTELLECTUAL PROPERTY GROUP, P.O. BOX 14300, WASHINGTON, DC, 20044-4300, US

(73) Assignee: NSK LTD., Shinagawa-ku (JP)

(21) Appl. No.: 11/210,901

(22) Filed: Aug. 25, 2005

(51) Int. Cl. F16C 13/00

(52) U.S. Cl. 384/544

(57) ABSTRACT

Upon assembling a hub unit, an inner race element is press-fitted onto a small diameter stepped portion of the hub, and thereafter an inner periphery of an axially extended hole of the hub is subjected to broaching to form a female serration extended in the axial direction, thereby providing a complete product.

### BACKGROUND OF THE INVENTION

1. Field of the Invention

The present invention relates to a bearing apparatus for a driving wheel that rotatably supports a driving wheel such as a rear wheel of an FR (Front engine/Rear drive) car, a front wheel of an FF (Front engine/Front drive) car and whole wheels of a 4 WD (4-Wheel Drive) car) of an automobile with respect to a suspension system, and to a working method thereof.

2. Related Background Art

In a hub unit for the driving wheel, the hub unit rotatably supports a hub (that is, a first inside member) and an inner race element (that is, a second inside member) through a plurality of rolling members on an inside-diameter side of an outer race (that is, an outer member) of a bearing.

The outer race (outer member) is fixed to a steering knuckle structuring a suspension system by use of a support flange provided on an outer peripheral surface of the outer race. An inner peripheral surface of the outer race (outer member) is formed with a plurality of outer ring raceways, and the hub (first inside member) and the inner race (second inside member) are supported on the inside-diameter side of the outer race (outer member).

A fitting flange for fitting a driving wheel is provided on an outer side end portion of the hub (first inside member). A first inner ring raceway is formed in an intermediate portion of an outer peripheral surface of the hub (first inside member). An inner race element (a second inside member) is fixedly fitted on a small-diameter stepped portion of an inner side end portion of the hub (first inside member).

This inner race element (second inside member) is formed with a second inner ring raceway. In the hub unit for the driving wheel, a central part of the hub (first inside member) is provided with a female serration portion for serration-fitting and thus fixing a male serration portion of a constant velocity universal joint.

FIGS. 22 through 25 show a conventional example of the driving wheel bearing apparatus (the hub unit for the driving wheel) of the automobile.

FIG. 22 is a sectional view of main components of the driving wheel bearing apparatus according to the conventional example, showing a first assembly process of the hub unit. FIG. 23 is a sectional view of the main components of the driving wheel bearing apparatus according to the conventional example, showing a second assembly process of the hub unit. FIG. 24 is a sectional view of the main components of the driving wheel bearing apparatus according to the conventional example, showing a third assembly process of the hub unit. FIG. 25 is a sectional view of the main components of the driving wheel bearing apparatus according to the conventional example, showing a fourth assembly process of the hub unit.

As shown in FIG. 22, an inner peripheral surface of an axis-directional hole 11 of a hub (first inside member) 8 is formed with a female serration portion 10 by previously effecting broaching as illustrated in FIG. 23.

Subsequently, as shown in FIG. 24, an outer race (outer member) 6 is fitted to an outer periphery of the hub (first inside member) 8 through rolling members (balls) 18. Next, an inner race element (second inside member) 12 is press-fitted on and thus fixed to the small-diameter stepped portion on the outer peripheral surface of the side end portion of the hub (first inside member) 8. As shown in FIG. 25, a driving wheel bearing apparatus (driving wheel hub unit) 5 is thus completed.

In the thus-completed driving wheel bearing apparatus (driving wheel hub unit) 5, as shown in FIG. 25, the hub (first inside member) 8 and the inner race element (second inside member) 12 are rotatably supported through the plurality of balls (rolling members) 18 on the inside-diameter side of the outer race (outer member) 6.

The outer race (outer member) 6 is fixedly joined to the steering knuckle structuring the suspension system by use of a bolt 7 via the support flange provided on the outer peripheral surface of the outer race 6.

The inner peripheral surface of the outer race (outer member) 6 is formed with a plurality of outer ring raceways 6a, 6a, and the hub (first inside member) 8 and the inner race element (second inside member) 12 are supported on the inside-diameter side of this outer race (outer member) 6.

The hub (first inside member) 8 is provided with a fitting flange 13 for fitting a wheel 1 etc of a traveling wheel to an outer periphery of the outer side end portion that is positioned outside a car body when fitted. Namely, an outer peripheral portion of the fitting flange 13 is formed with a plurality of hub bolt holes 14 disposed at an equal interval in a circumferential direction, and the wheel 1 etc. of the traveling wheel is secured by a hub bolt 9.

The intermediate portion of the outer peripheral surface of the hub (first inside member) 8 is formed with a first inner ring raceway 8a, and similarly the inner race element (second inside member) 12 is fixedly fitted on a small-diameter stepped portion 15 taking a cylindrical shape, which is formed at the inner side end portion. This inner race element (second inside member) 12 is formed with a second inner ring raceway 12a. Note that the small-diameter stepped portion 15 is formed by machining.

The female spline portion 10 is formed in the axis-directional hole 11 of the hub (first inside member) 8. An outer joint member as a male spline shaft of the constant velocity joint (constant velocity universal joint) is spline-fitted to the female spline portion 10. Note that the plurality of balls (rolling members) 18 are held by a cage (retainer) 19.

As described above, in the conventional examples in FIGS. 22 through 25, the driving wheel bearing apparatus (driving wheel hub unit) 5 is unitized, thereby scheming to attain a compact configuration and a decrease in weight.

Further, there is such a type that after press-fitting the inner race element (second inside member) 12, the inner side end portion of the hub (first inside member) 8 is plastically deformed by caulking or clinching. In this case, a preload in an interior of the bearing can be controlled.

Moreover, when securing the driving wheel hub unit to a car body, the outer joint member (male serration portion) of the constant velocity universal joint for transmitting torque by meshing between serration toothed portions, is fitted to the female serration portion of the hub (first inside member) 8.

Japan Patent Application Laid-Open No.2002-317824 discloses a construction that when the inner peripheral surface of the axis-directional hole of the hub is formed with the female spline portion, the inner race is previously fitted on the small-diameter stepped portion of the inner side end portion of the hub, and the female spline portion is machined in this state, whereby an amount of elastic deformation of the inner side end portion of the hub can be compensated.

Further, Japan Patent Application Laid-Open No.2002-339959 discloses a construction that when effecting a caulking or clinching work upon the inner side end portion of the hub, a deformation preventive jig is previously inserted into the inner side end portion of the hub, and thereafter the caulking or clinching work is conducted, whereby the inner side end portion of the hub can be prevented from deforming inwards in the radial direction.

In the structure of the driving wheel bearing apparatus according to the conventional examples shown in FIGS. 22 through 25, however, when press-fitting the inner race element (second inside member) 12 on an outer periphery of the hub (first inside member) 8, as shown in FIG. 24, an interference needs providing between an outside-diameter dimension φA of the hub (first inside member) 8 and an inside-diameter dimension φB of the inner race element (second inside member) 12.

Accordingly, it might happen that the inner side end portion of the hub (first inside member) 8, particularly, an inner peripheral portion 31 of a press-fitting portion vicinity 30 reduces in its diameter due to the press-fitting.

As shown in FIG. 25, a dimension of the inner peripheral portion 31 is given by φ(D−2ΔX), where 2ΔX is a reduced diameter quantity. Hence, it follows that an overpin diameter of the female serration portion 10 provided in the inner peripheral portion 31 of the hub (first inside member) 8 is similarly reduced.

As a result, an overpin diameter of the male serration portion of the constant velocity universal joint gets larger than the overpin diameter of the hub (first inside member) 8, resulting in having the interference.

In the worst case, there might be a possibility that the male serration portion of the constant velocity universal joint can not inserted into the female serration portion 10 of the hub (first inside member) 8.

### SUMMARY OF THE INVENTION

It is an object of the present invention, which was devised under such circumstances, to provide a driving wheel bearing apparatus and a working method thereof, which are capable of facilitating smooth assembling of a constant velocity universal joint by preventing an inner side end portion of a hub (a first inside member) from reducing in its diameter.

To accomplish the above object, a bearing apparatus for a driving wheel according to a first aspect of the present invention comprises an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a state where the second inside member is press-fitted onto the first inside member, and a plurality of rolling members interposed between the outer member and the inner member, said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member, the inner periphery of the first inside member is subjected to broaching for forming the serration extending in the axial direction, thus acquiring a complete product.

A bearing apparatus for a driving wheel according to a second aspect of the present invention comprises an outer member having a plurality of outer ring raceways formed along an inner periphery;

an inner member having a plurality of inner ring raceways opposed to the outer ring raceways of the outer member, a first inside member and a second inside member formed with at least one of the plurality of inner ring raceways, the first inside member and the second inside member being joined in a state where the second inside member is press-fitted onto the first inside member, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member subjected to broaching beforehand, the serration extending in the axial direction along the inner periphery of the first inside member is subjected to the broaching once again, thus acquiring a complete product.

A bearing apparatus for a driving wheel according to a third aspect of the present invention comprises an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a non-separable manner at a flange-shaped plastically deformed portion formed by plastically deforming an end portion of the first inside member towards an outside diameter, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member, the inner periphery of the first inside member is subjected to broaching for forming the serration extending in the axial direction and the end of the first inside member is subsequently plastically deformed.

A bearing apparatus for a driving wheel according to a fourth aspect of the present invention comprises an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a non-separable manner at a flange-shaped plastically deformed portion formed by plastically deforming an end portion of the first inside member towards an outside diameter, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member subjected to broaching beforehand, serration extending in the axial direction along the inner periphery of the first inside member is subjected to the broaching once again and the end of the first inside member is subsequently plastically deformed by caulking or clinching.

In a driving wheel bearing apparatus according to any one of the first through fourth aspects of the present invention, it is preferable that a preliminary hole formed in the first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting the second inside member into the first inside member.

A working method according to a fifth aspect of the present invention is a method of working a bearing apparatus for a driving wheel comprising an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a state where the second inside member is press-fitted onto the first inside member, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member, the inner periphery of the first inside member is subjected to broaching for forming the serration extending in the axial direction, thus acquiring a complete product.

A working method according to a sixth aspect of the present invention is a method of working a bearing apparatus for a driving wheel comprising an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a state where the second inside member is press-fitted onto the first inside member, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member subjected to broaching beforehand, the serration extending in the axial direction along the inner periphery of the first inside member is subjected to the broaching once again, thus acquiring a complete product.

A working method according to a seventh aspect of the present invention is a method of working a bearing apparatus for a driving wheel comprising an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a non-separable manner at a flange-shaped plastically deformed portion formed by plastically deforming an end portion of the first inside member towards an outside diameter, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member, the inner periphery of the first inside member is subjected to broaching for forming the serration extending in the axial direction and the end of the first inside member is subsequently plastically deformed.

A working method according to an eighth aspect of the present invention is a method of working a bearing apparatus for a driving wheel comprising an outer member having a plurality of outer ring raceways formed along an inner periphery, an inner member having a plurality of inner ring raceways opposed to the outer ring raceways of the outer member, a first inside member and a second inside member formed with at least one of the plurality of inner ring raceways, the first inside member and the second inside member being joined in a non-separable manner at a flange-shaped plastically deformed portion formed by plastically deforming an end portion of the first inside member towards an outside diameter, and a plurality of rolling members interposed between the outer member and the inner member,

said bearing apparatus being press-fitted therein with an outer joint member of a constant velocity universal joint through torque transmission means for transmitting torque in such a way that toothed portions of serration of the outer joint member and toothed portions of serration extending along an inner periphery of the first inside member in an axial direction mesh with each other, wherein after the second inside member has been press-fitted onto the first inside member subjected to broaching beforehand, serration extending in the axial direction along the inner periphery of the first inside member is subjected to the broaching once again and the end of the first inside member is subsequently plastically deformed.

In a working method of a driving wheel bearing apparatus according to any one of the fifth through eighth aspects of the present invention, it is preferable that a preliminary hole formed in the first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting the second inside member to the first inside member.

According to the present invention, after press-fitting the second inside member on the first inside member, the inner periphery of the first inside member is subjected to the broaching for forming the serration extending in the axial direction thereof, thus acquiring the complete product. It is therefore possible to facilitate smooth assembling of a constant velocity universal joint by preventing the inner side end portion of the hub (first inside member) from reducing in its diameter.

Namely, in the press-fitting portion vicinity of the second inside member of the torque transmission toothed portion formed in the inner periphery of the first inside member, there is eliminated deformation of the serration due to a diameter-reduced phenomenon caused by the press-fitting of the second inside member to the first inside member, and thereafter, on the occasion of press-fitting the outer joint member to the inner periphery of the first inside member, the smooth press-fitting operation can be done without any excess of a press-fitting force. Besides, it is feasible to prevent an adverse influence of the diameter-reduced phenomenon of the hub wheel that is caused by press-fitting the second inside member at a low cost in a way that keeps a merit of an effective length of the torque transmission toothed portion.

### BRIEF DESCRIPTION OF THE DRAWINGS

FIG. 1 is a vertical sectional view of a driving wheel bearing apparatus as a driving wheel hub unit according to the present invention;

FIG. 2 is a sectional view of main components of the driving wheel bearing apparatus as the driving wheel hub unit shown in FIG. 1 (FIG. 2 is, however, an illustration reversed in its right-and-left directions as compared with FIG. 1);

FIG. 3 is a sectional view of main components in another example of the driving wheel bearing apparatus (driving wheel hub unit) according to the present invention;

FIG. 4 is a sectional view of the main components of the driving wheel bearing apparatus according to a first embodiment of the present invention, showing a first assembly process of the hub unit;

FIG. 5 is a sectional view of the main components of the driving wheel bearing apparatus according to the first embodiment of the present invention, showing a second assembly process of the hub unit;

FIG. 6 is a sectional view of the main components of the driving wheel bearing apparatus according to the first embodiment of the present invention, showing a third assembly process of the hub unit;

FIG. 7 is a sectional view of the main components of the driving wheel bearing apparatus according to the first embodiment of the present invention, showing a fourth assembly process of the hub unit;

FIG. 8 is a sectional view of the main components of the driving wheel bearing apparatus according to a second embodiment of the present invention, showing a first assembly process of the hub unit;

FIG. 9 is a sectional view of the main components of the driving wheel bearing apparatus according to the second embodiment of the present invention, showing a second assembly process of the hub unit;

FIG. 10 is a sectional view of the main components of the driving wheel bearing apparatus according to the second embodiment of the present invention, showing a third assembly process of the hub unit;

FIG. 11 is a sectional view of the main components of the driving wheel bearing apparatus according to the second embodiment of the present invention, showing a fourth assembly process of the hub unit;

FIG. 12 is a sectional view of the main components of the driving wheel bearing apparatus according to a third embodiment of the present invention, showing a first assembly process of the hub unit;

FIG. 13 is a sectional view of the main components of the driving wheel bearing apparatus according to the third embodiment of the present invention, showing a second assembly process of the hub unit;

FIG. 14 is a sectional view of the main components of the driving wheel bearing apparatus according to the third embodiment of the present invention, showing a third assembly process of the hub unit;

FIG. 15 is a sectional view of the main components of the driving wheel bearing apparatus according to the third embodiment of the present invention, showing a fourth assembly process of the hub unit;

FIG. 16 is a sectional view of the main components of the driving wheel bearing apparatus according to the third embodiment of the present invention, showing a fifth assembly process of the hub unit;

FIG. 17 is a sectional view of the main components of the driving wheel bearing apparatus according to a fourth embodiment of the present invention, showing a first assembly process of the hub unit;

FIG. 18 is a sectional view of the main components of the driving wheel bearing apparatus according to the fourth embodiment of the present invention, showing a second assembly process of the hub unit;

FIG. 19 is a sectional view of the main components of the driving wheel bearing apparatus according to the fourth embodiment of the present invention, showing a third assembly process of the hub unit;

FIG. 20 is a sectional view of the main components of the driving wheel bearing apparatus according to the fourth embodiment of the present invention, showing a fourth assembly process of the hub unit;

FIG. 21 is a sectional view of the main components of the driving wheel bearing apparatus according to the fourth embodiment of the present invention, showing a fifth assembly process of the hub unit;

FIG. 22 is a sectional view of main components of a driving wheel bearing apparatus according to a conventional example, showing a first assembly process of a hub unit;

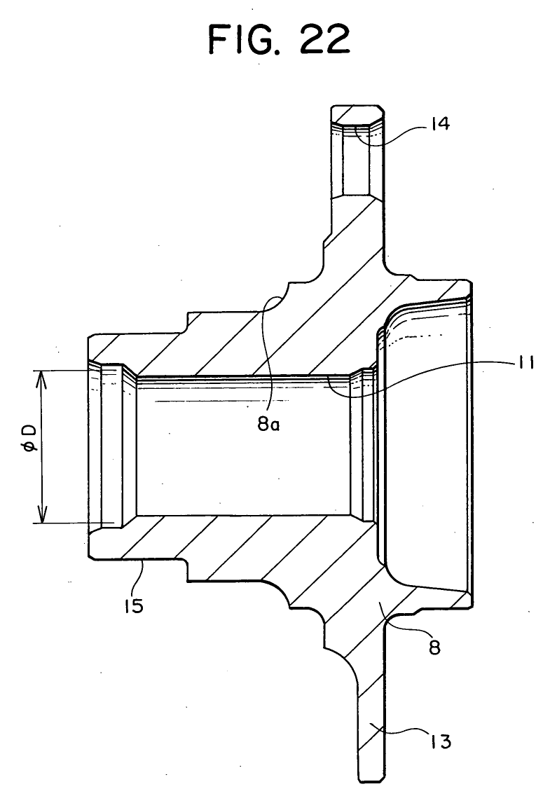

FIG. 23 is a sectional view of the main components of the driving wheel bearing apparatus according to the conventional example, showing a second assembly process of the hub unit;

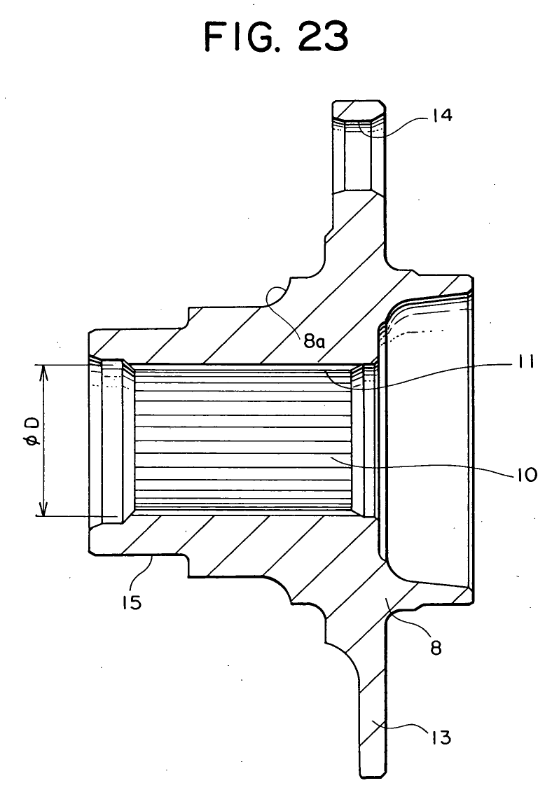

FIG. 24 is a sectional view of the main components of the driving wheel bearing apparatus according to the conventional example, showing a third assembly process of the hub unit; and

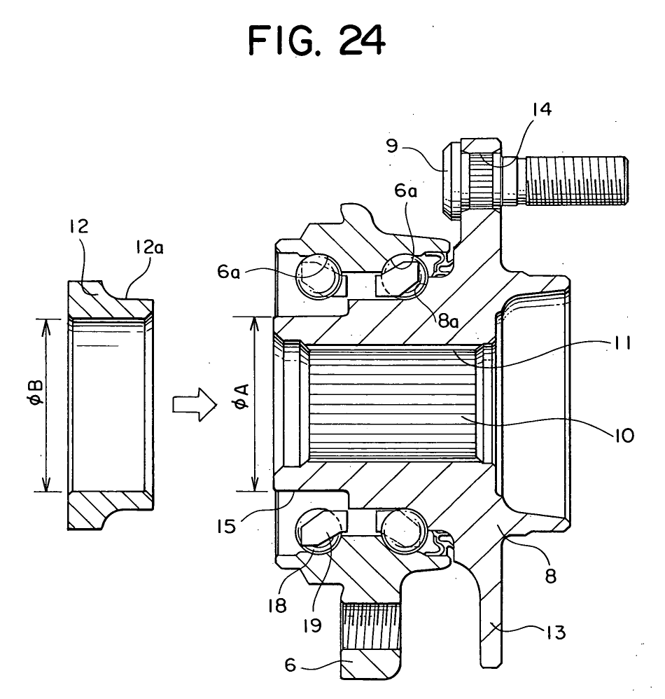

FIG. 25 is a sectional view of the main components of the driving wheel bearing apparatus according to the conventional example, showing a fourth assembly process of the hub unit.

### DETAILED DESCRIPTION OF THE PREFERRED EMBODIMENT

A bearing apparatus for a driving wheel and a working method thereof according to embodiments of the present invention will hereinafter be described with reference to the drawings.

(Whole Construction of Driving Wheel Hub Unit as Driving Wheel Bearing Apparatus)

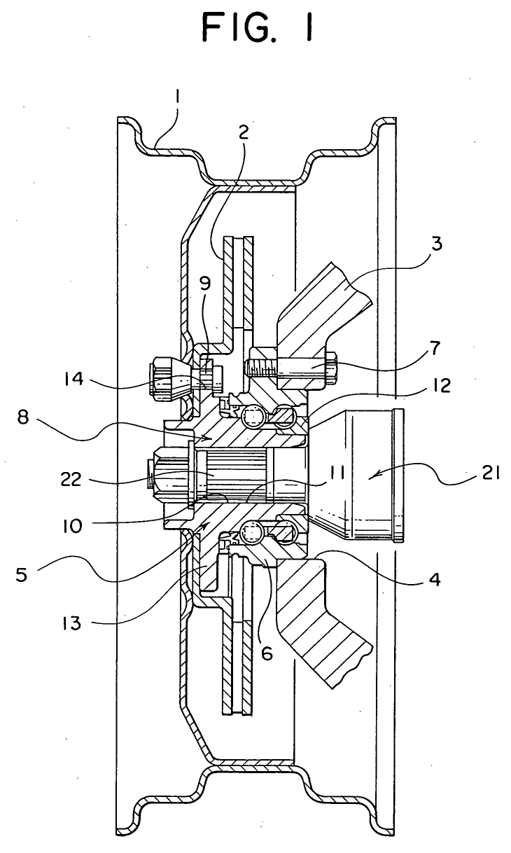

FIG. 1 is a vertical sectional view of the driving wheel bearing apparatus (driving wheel hub unit) according to the present invention.

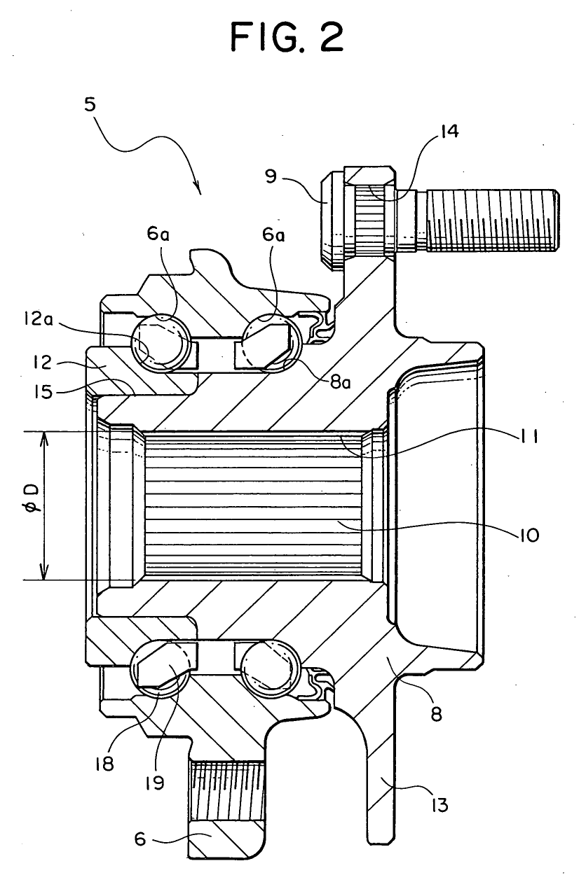

FIG. 2 is a sectional view of main components of the driving wheel bearing apparatus (driving wheel hub unit) shown in FIG. 1 (FIG. 2 is, however, an illustration reversed in its right-and-left directions as compared with FIG. 1).

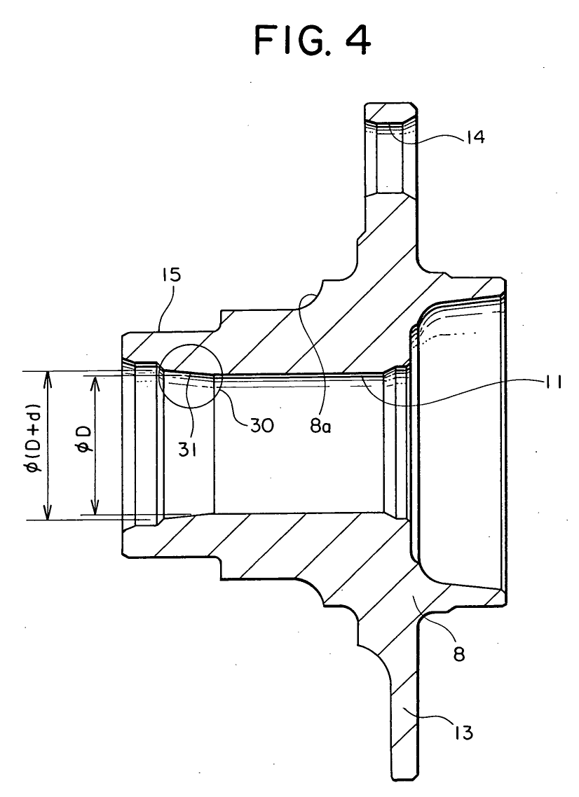

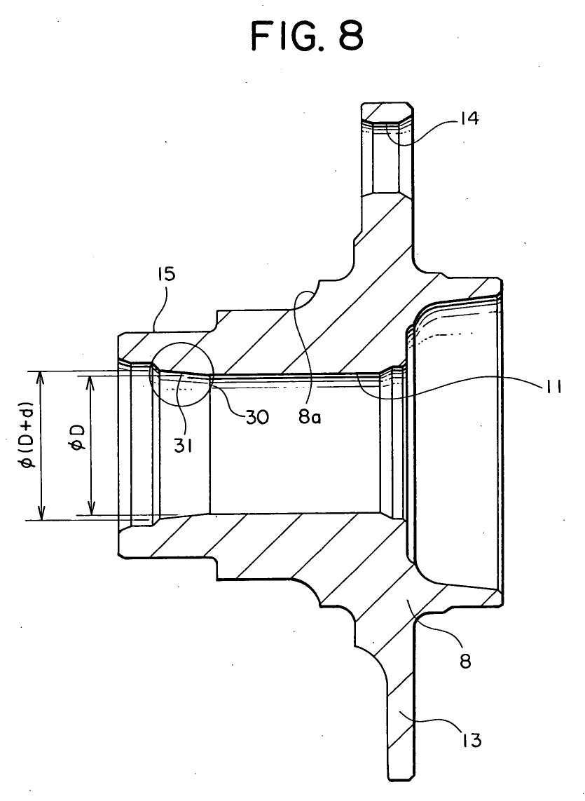

Note that the driving wheel bearing apparatus (driving wheel hub unit) corresponds to a first embodiment (i.e., a non-caulking or non-clinching type) shown in FIGS. 4 through 7 and to a second embodiment (non-caulking or non-clinching type) shown in FIGS. 8 through 11, which will be described later on.

In a driving wheel bearing apparatus (driving wheel hub unit) 5, a hub 8 defined as a first inside member and an inner race element 12 defined as a second inside member are rotatably supported via a plurality of rolling members 18 constructed of balls on an inside-diameter side of an outer race 6 defined as an outer member.

The outer race (outer member) 6 is fixedly joined to a steering knuckle 3 structuring a suspension device by use of a bolt 7 through a support flange provided on an outer peripheral surface of the outer race 6. Further, part of the outer race (outer member) 6 is inserted into a support hole 4 of the knuckle 3. An inner peripheral surface of the outer race (outer member) 6 is formed with a plurality of outer ring raceways 6a, 6a, and the hub (first inside member) 8 and the inner race element (second inside member) 12 are supported on an inside diameter side of this outer race (outer member) 6.

The hub (first inside member) 8 is provided integrally with a fitting flange 13 for fitting a traveling wheel 1 and a brake disc rotor 2. An outer peripheral portion of the fitting flange 13 is formed with a plurality of hub bolt holes 14 disposed at an equal interval in a circumferential direction, and the traveling wheel 1 and the brake disc rotor 2 are fitted by bolts 9.

An intermediate portion of the outer peripheral surface of the hub (first inside member) 8 is formed with a first inner ring raceway (first inner raceway) 8a, and an inner race element (second inside member) 12 is fixedly fitted on a cylindrical small-diameter stepped portion 15 formed at an inner side end portion. This inner race element (second inside member) 12 is formed with a second inner ring raceway 12a. The small-diameter stepped portion 15 is formed by machining.

A female spline portion 10 is formed in an axis-directional hole 11 of the hub (first inside member) 8. A male spline shaft 22 defined as an outer joint member of a constant velocity joint (that is, constant velocity universal joint) 21 is spline-fitted to the female spline portion 10.

Note that the plurality of balls (rolling members) 18 are held by a cage (retainer) 19.

(Another Example of Whole Construction of Driving Wheel Bearing Apparatus (Driving Wheel Hub Unit))

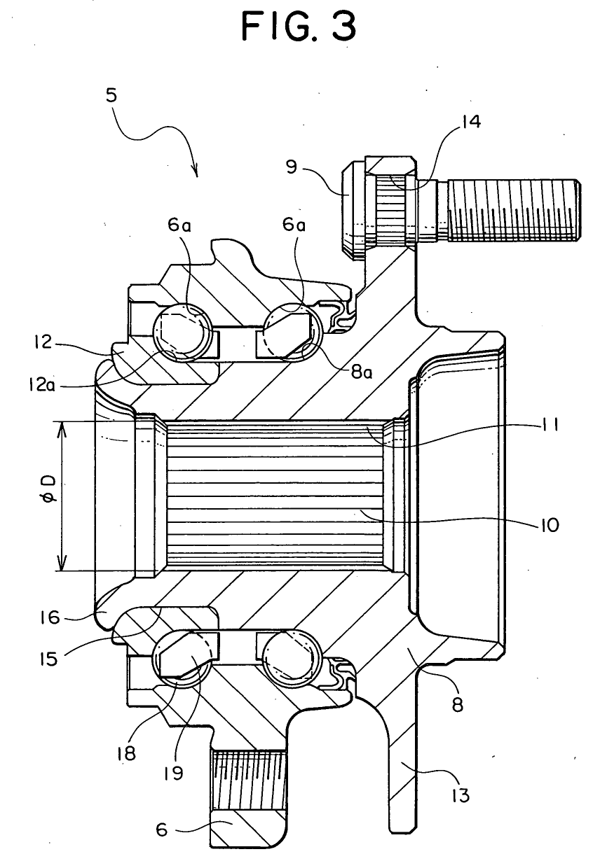

FIG. 3 is a sectional view of main components in another example of the driving wheel hub unit defined as the driving wheel bearing apparatus according to the present invention.

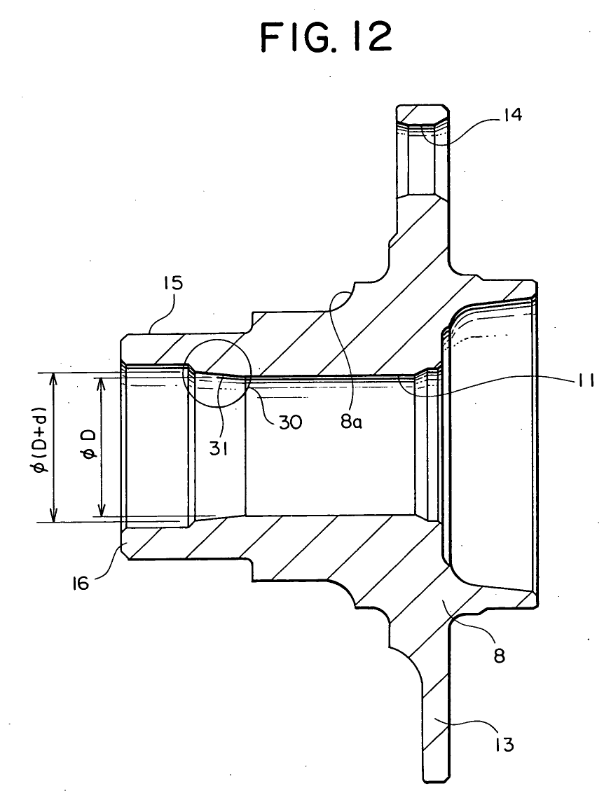

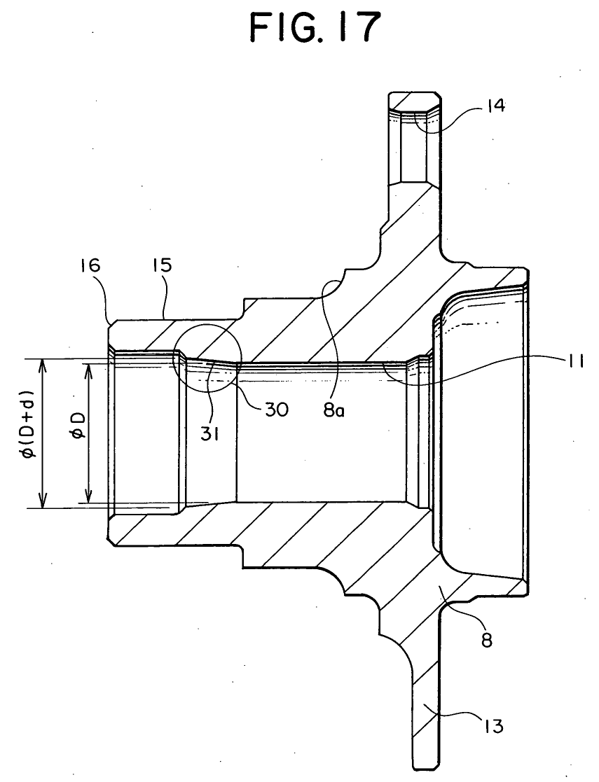

The driving wheel bearing apparatus (driving wheel hub unit) illustrated in FIG. 3 corresponds to a third embodiment (caulking or clinching type) shown in FIGS. 12 through 16 and a fourth embodiment (caulking or clinching type) shown in FIGS. 17 through 21, which will hereinafter be described.

The third and fourth embodiments are different from the driving wheel bearing apparatus (driving wheel hub unit) shown in FIGS. 1 and 2 in terms of such a point that the inner side end portion of the hub (first inside member) 8 is subjected to plastic deformation working by caulking or clinching.

Namely, the inner race element (second inside member) 12 is press-fitted on the small-diameter stepped portion 15 of the hub (first inside member) 8, and thereafter an inner side end portion 16 of the hub (first inside member) 8 is plastically deformed by caulking or clinching. In this case, a preload in an interior of the bearing can be controlled. Other configurations, operations, etc are substantially the same as those of the driving wheel bearing apparatus (driving wheel hub unit) shown in FIGS. 1 and 2.

When plastically deforming the inner side end portion 16 of the hub (first inside member) 8 by caulking or clinching, as disclosed in Japan Patent Application Laid-Open No.2002-33995, a configuration may be such that a deformation preventive jig is previously inserted into the inner side end portion 16 of the hub (first inside member) 8, and thereafter the inner side end portion 16 is subjected to the plastic deforming by caulking or clinching, thereby making it possible to prevent the inner side end portion 16 of the hub (first inside member) 8 from deforming inwardly in the diameter direction. In this case, an adverse influence of the plastically deforming by caulking or clinching upon the female serration portion 10 can be further reduced.

(First Embodiment)

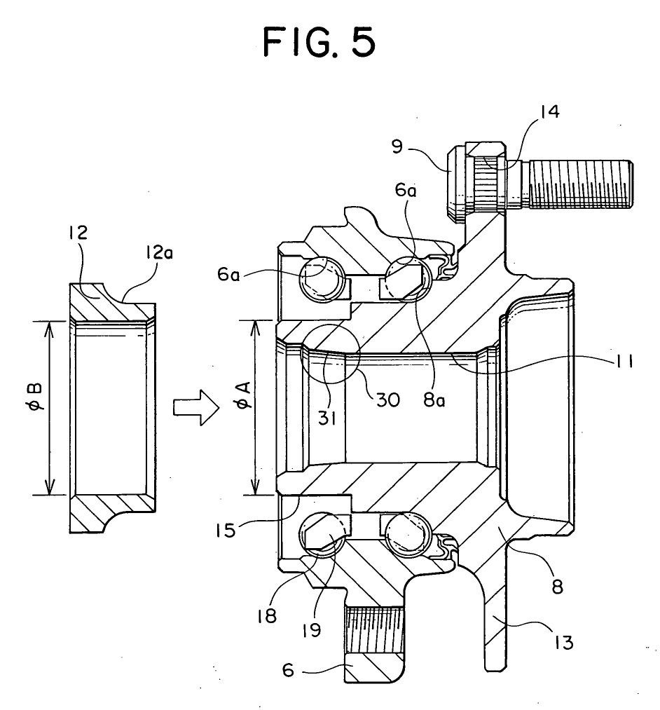

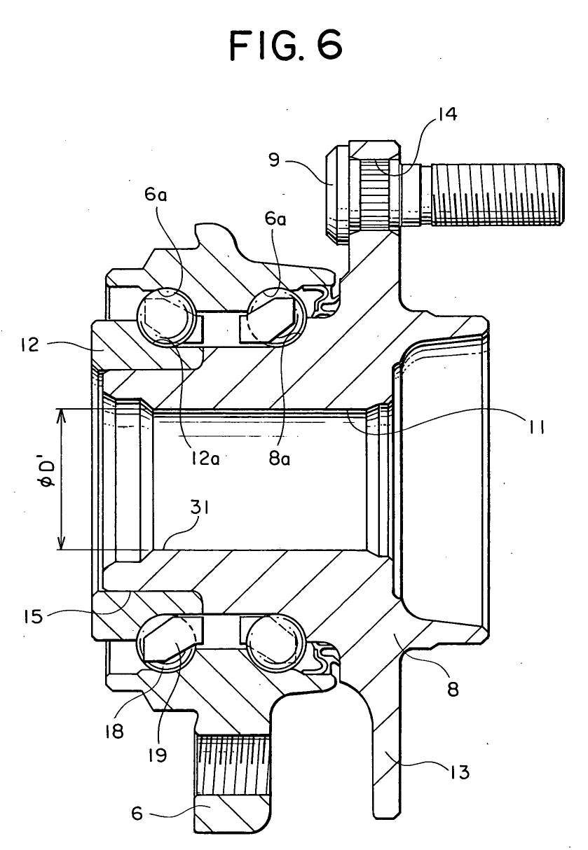

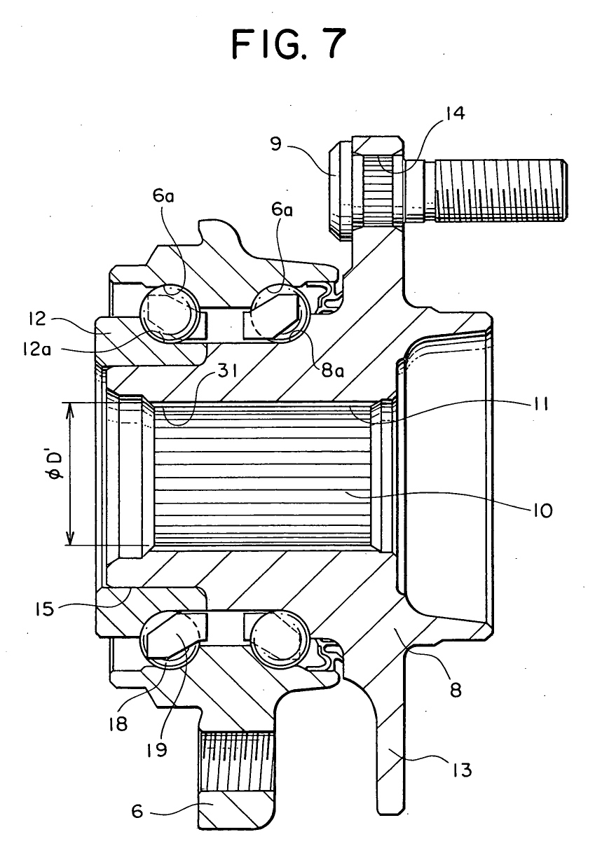

FIG. 4 is a sectional view of the main components of the driving wheel bearing apparatus according to a first embodiment of the present invention, showing a first assembly process of the hub unit. FIG. 5 is a sectional view of the main components of the driving wheel bearing apparatus according to the first embodiment of the present invention, showing a second assembly process of the hub unit. FIG. 6 is a sectional view of the main components of the driving wheel bearing apparatus according to the first embodiment of the present invention, showing a third assembly process of the hub unit. FIG. 7 is a sectional view of the main components of the driving wheel bearing apparatus according to the first embodiment of the present invention, showing a fourth assembly process of the hub unit.

In the first assembly process in FIG. 4, FIG. 4 shows, as a state of a single unit before being assembled, the hub (first inside member) 8 as one element of a driving wheel bearing apparatus 5 shown in FIG. 2.

The flange 13 has been integrally formed on an outboard side of the hub (first inside member) 8, wherein the traveling wheel is to be fitted, and an outer periphery of the flange 13 has been formed with the plurality of hub bolt holes 14 disposed at the equal interval in the circumferential direction. Formed further by machining has been an outside-diameter portion which is a small-diameter stepped portion 15, onto which the inner race element (second inside member) 12 is press-fitted at an inboard side, wherein the driving wheel bearing apparatus 5 of the hub (first inside member) 8, is secured to a car body. Moreover, an inner peripheral surface of the axis-directional hole 11 serves as a reference surface for broaching.

In the second assembly process shown in FIG. 5, the elements configuring the driving wheel bearing apparatus 5 such as the outer race (outer member) 6 having the plurality of outer ring raceways 6a, 6a formed along the inner peripheral surface, the plurality of balls 18 and the cage 19 are fitted to the hub (first inside member) 8, and thereafter the inner race element (second inside member) 12 is press-fitted onto the hub (first inside member) 8.

At this time, an interference is provided between an outside-diameter dimension φA of the hub (first inside member) 8 and an inside-diameter dimension φB of the inner race element (second inside member) 12, whereby particularly an inner peripheral portion 31 of a press-fitting portion vicinity 30 of the hub (first inside member) 8 is, as described earlier, reduced in diameter with the result that an inside-diameter dimension of this inner peripheral portion 31 comes to φD′.

This inner peripheral portion 31 becomes the reference for the broaching to be effected later on, and hence, if the inside-diameter dimension of the inner peripheral portion 31 is reduced down to φD′, a broach as a broaching tool is caught by the diameter-reduced part of the inner peripheral portion 31, with the result that the broaching can not be performed.

Therefore, a contrivance of the first embodiment is that the inside-diameter dimension of the inner peripheral portion 31 of the hub (inner member) 8 is, as illustrated in FIG. 4, previously set larger by+φd into φ(D+d) in a way that takes account of a contraction quantity, whereby the inside-diameter dimension φ(D+d) can be set such as φD′≧φD even when reduced in diameter.

As for the quantity+φd taking account of the contraction quantity produced by the reduction in diameter, a scatter or fluctuation occurs to some extent in a total contraction quantity due to the interference between the outside-diameter dimensionφA of the hub (first inside member) 8 and the inside-diameter dimension φB of the inner race element (second inside member) 12, so that a quantity Δα should be added to the quantity φd.

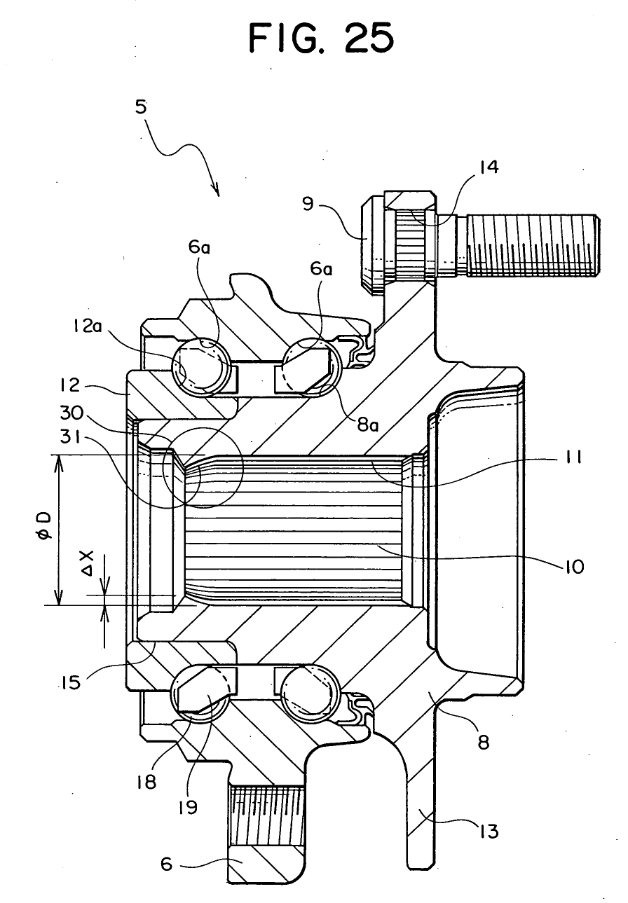

As shown in FIG. 25, the contraction quantity of the inner peripheral portion 31 becomes larger in area closer to the press-fitting portion vicinity 30. Further, not being the uniform deformation, it is desirable that, for example, as shown in FIG. 4, the dimension and the shape be set to obtain such a tapered shape that the inside-diameter dimension of the inner peripheral portion 31 increases towards the inboard side. Even when the inner race (second inside member) 12 is press-fitted to this hub (first inside member) 8 afterwards, it is possible to attain the inner peripheral portion 31 to have the inside-diameter dimension φD′ substantially in a uniform cylindrical shape.

Subsequently, as shown in FIG. 7, the inner peripheral portion 31 of the hub (first inside member) 8 and the axis-directional hole 11 are subjected to the broaching on the basis of the inside-diameter dimensions φD′ and φD taking substantially the uniform cylindrical shape, as the references, whereby it is possible to form the female serration portion 10 having dimensional data (specification) that is as accurate as causing no deformation by press-fitting.

This technique is carried out in a semi-complete state of the driving wheel bearing apparatus 5, and the broaching needs carrying out by dry working or semi-dry working. Further, there may be provided a cover for preventing chips produced when effecting the broaching from entering an interior of the driving wheel bearing apparatus 5.

This contrivance enables acquisition of the driving wheel bearing apparatus 5 provided with the female serration portion 10 having the highly accurate dimensional data, and obviates such a problem that the outer joint member 22 of the constant velocity universal joint 21 can not be press-fitted into the female serration portion 10 of the driving wheel bearing apparatus 5.

(Second Embodiment)

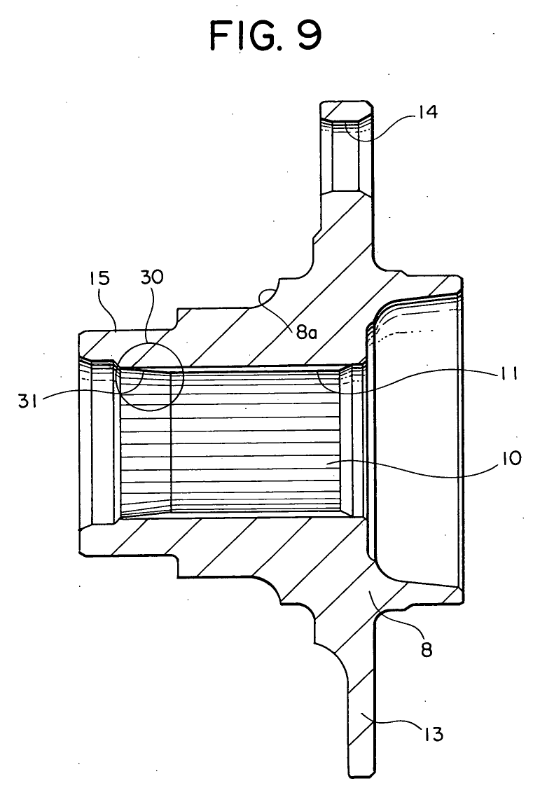

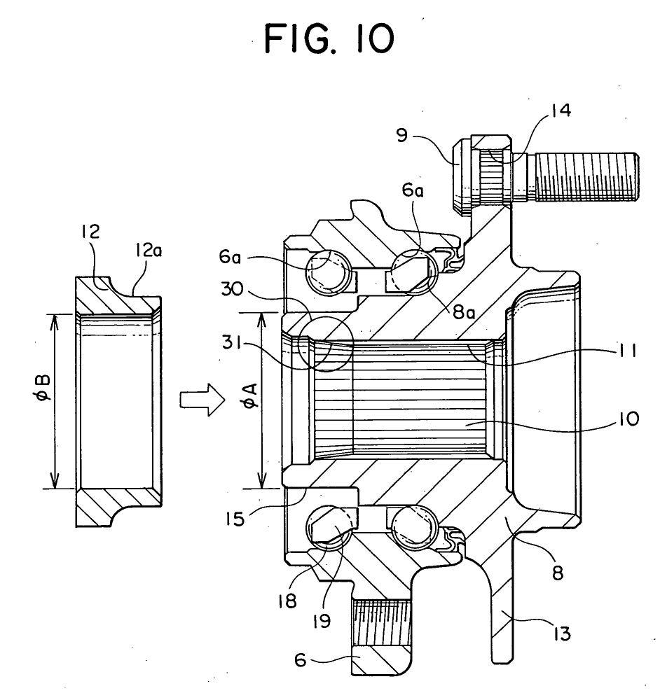

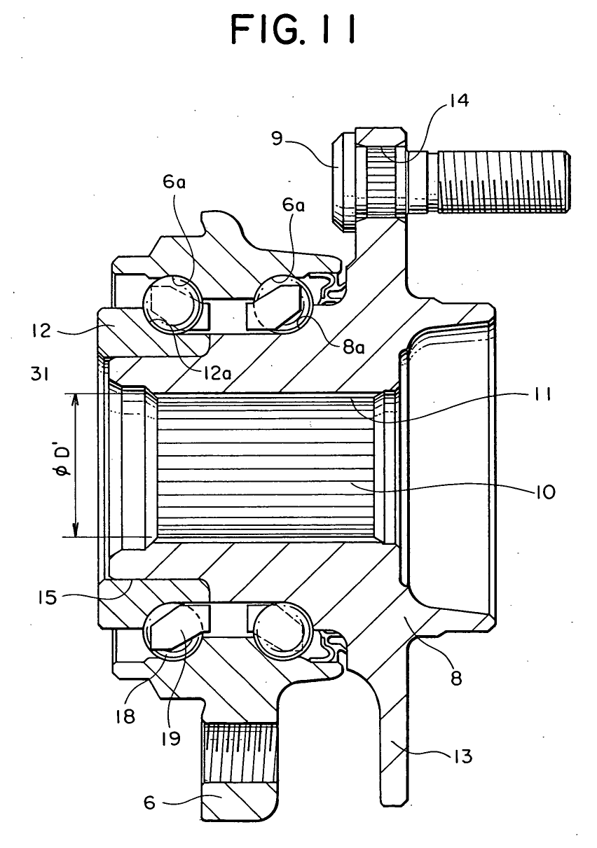

FIG. 8 is a sectional view of the main components of the driving wheel bearing apparatus according to a second embodiment of the present invention, showing a first assembly process of the hub unit. FIG. 9 is a sectional view of the main components of the driving wheel bearing apparatus according to the second embodiment of the present invention, showing a second assembly process of the hub unit. FIG. 10 is a sectional view of the main components of the driving wheel bearing apparatus according to the second embodiment of the present invention, showing a third assembly process of the hub unit. FIG. 11 is a sectional view of the main components of the driving wheel bearing apparatus according to the second embodiment of the present invention, showing a fourth assembly process of the hub unit.

In the first assembly process in FIG. 8, FIG. 8 shows, as a state of a single unit before being assembled, the hub (first inside member) 8 as one element of the driving wheel bearing apparatus 5 in FIG. 2.

The flange 13 to which the traveling wheel is to be fitted, has been formed on the outboard side of the hub (first inside member) 8, and the outer periphery of the flange 13 has been formed with the plurality of hub bolt holes 14 disposed at the equal interval in the circumferential direction. Formed further by machining has been the outside-diameter portion (small-diameter stepped portion 15) onto which the inner race (second inside member) 12 is press-fitted at the inboard side, wherein the driving wheel bearing apparatus 5 of the hub (first inside member) 8, is secured to the car body.

After the inner peripheral surface of the axis-directional hole 11, as shown in FIG. 8, has been formed with the tapered portion as described above, the female serration portion 10 extending from the flange 13 serving as a hub wheel to the other side end in the axial direction, is previously provided by the broaching, in the second assembly process in FIG. 9.

This female serration portion 10 is a portion, into which the outer joint member 22 of the constant velocity universal joint 21 is press-fitted later on, and torque is transmitted by meshing the female serration portion 10 with a toothed portion of the male serration provided on the outer joint member 22 of the constant velocity universal joint 21.

The elements configuring the driving wheel bearing apparatus 5 such as the outer member 6 having the plurality of outer ring raceways 6a, 6a formed along the inner peripheral surface, the plurality of balls 18 and the cage 19 are, as shown in FIG. 10, fitted to the hub (first inside member) 8, and thereafter the inner race (second inside member) 12 is press-fitted to the hub (first inside member) 8.

At this time, however, the interference is provided between the outside-diameter dimension φA of the hub (first inside member) 8 and the inside-diameter dimension φB of the inner race element (second inside member) 12, whereby particularly the female serration portion 10 of the inner peripheral portion 31 of the press-fitting portion vicinity 30 of the hub (first inside member) 8 is, as described earlier, reduced in diameter.

Then, according to the second embodiment, in a state shown n FIG. 11, on the basis of the small-diameter portion taking substantially the uniform cylindrical shape, the female serration portion 10 provided beforehand by the broaching in the axis-directional hole 11 of the hub (first inside member) 8 is again subjected to the broaching, whereby the female serration portion 10 having the highly accurate dimensional data can be provided by modifying an overpin diametrical dimension and a large diametrical dimension that have been changed due to the press-fitting.

At this time, the small diametrical dimension may be simultaneously modified depending on the dimensional data of the serration. Further, on the occasion of conducting the broaching once again, the broaching needs effecting in a way that adjusts the broach as the broaching tool to a phase of the female serration portion 10 in FIG. 11. Hence, it is preferable that a guide following the female serration portion 10 is provided at a front tooth of the broach on the occasion of performing the broaching once again.

Moreover, this technique is carried out in the semi-complete state of the driving wheel bearing apparatus 5, and the broaching needs carrying out by dry working or semi-dry working. Further, there may be provided the cover for preventing chips produced when effecting the broaching from entering the interior of the driving wheel bearing apparatus 5.

This contrivance enables the acquisition of the driving wheel bearing apparatus 5 provided with the female serration portion 10 having the highly accurate dimensional data, and obviates such a problem that the outer joint member 22 of the constant velocity universal joint 21 can not be press-fitted into the female serration portion 10 of the driving wheel bearing apparatus 5.

(Third Embodiment)

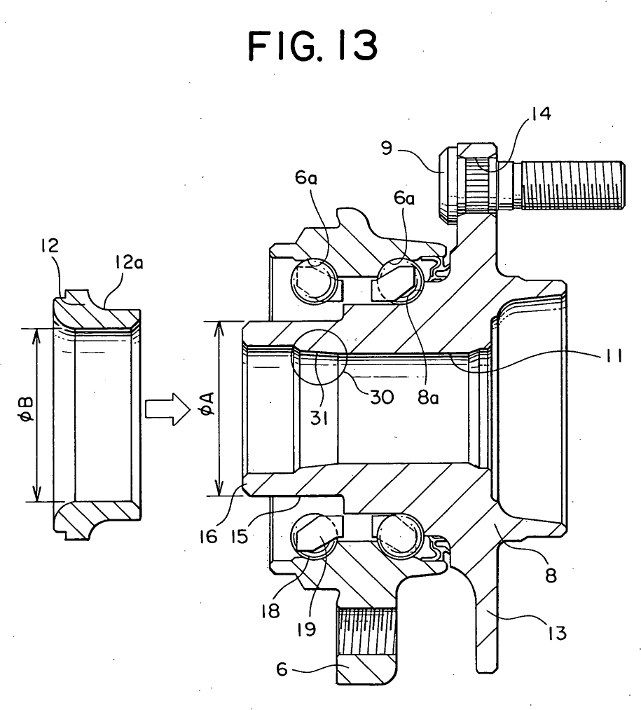

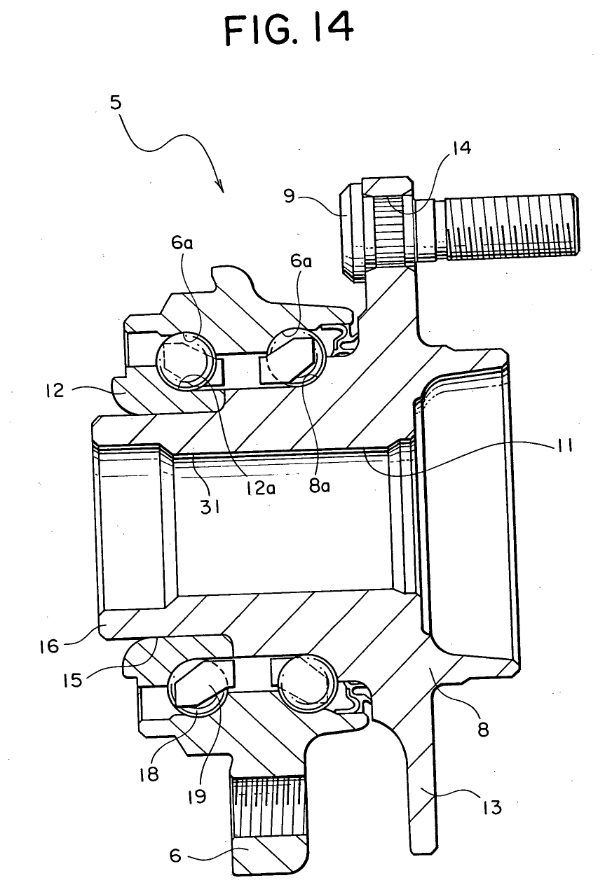

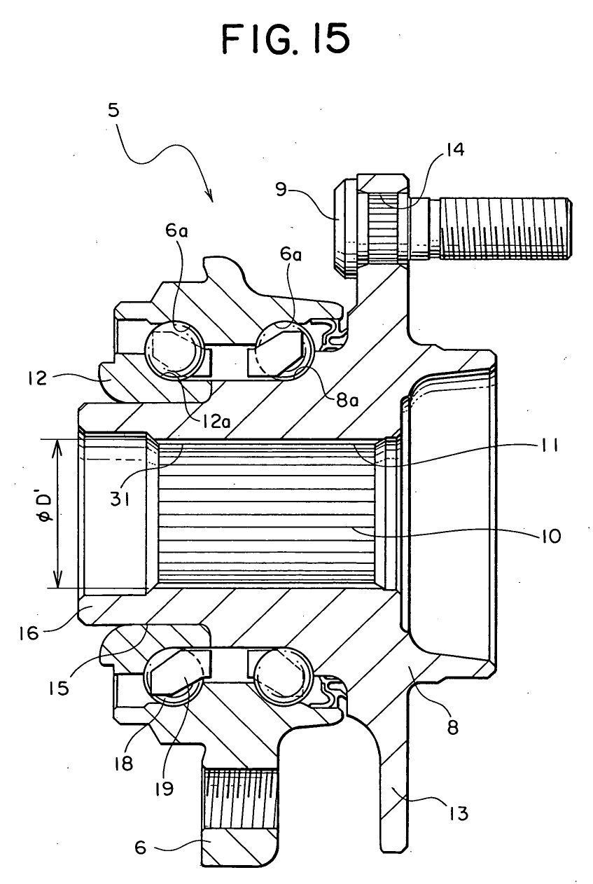

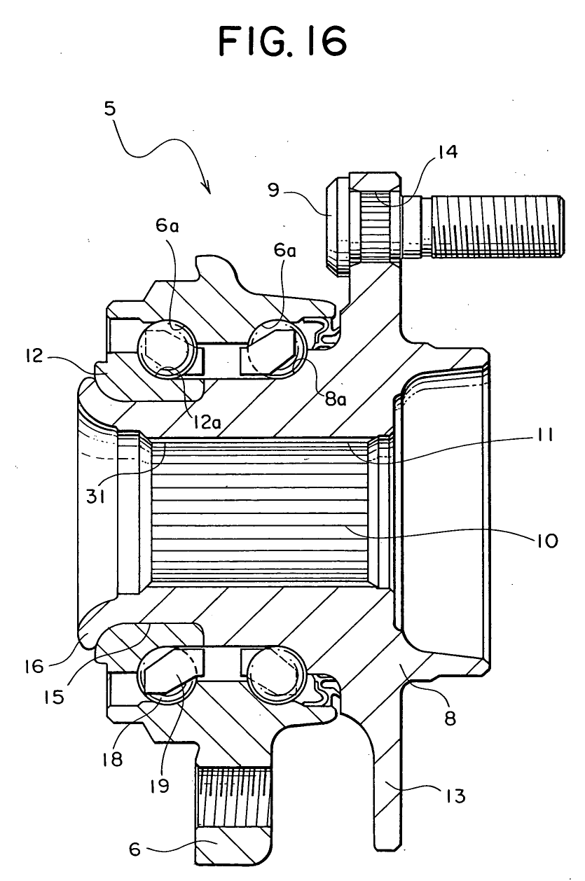

FIG. 12 is a sectional view of the main components of the driving wheel bearing apparatus according to a third embodiment of the present invention, showing a first assembly process of the hub unit. FIG. 13 is a sectional view-of the main components of the driving wheel bearing apparatus according to the third embodiment of the present invention, showing a second assembly process of the hub unit. FIG. 14 is a sectional view of the main components of the driving wheel bearing apparatus according to the third embodiment of the present invention, showing a third assembly process of the hub unit. FIG. 15 is a sectional view of the main components of the driving wheel bearing apparatus according to the third embodiment of the present invention, showing a fourth assembly process of the hub unit. FIG. 16 is a sectional view of the main components of the driving wheel bearing apparatus according to the third embodiment of the present invention, showing a fifth assembly process of the hub unit.

In the first assembly process in FIG. 12, FIG. 12 shows, as a state of a single unit before being assembled, the hub (first inside member) 8 as one element of a driving wheel bearing apparatus 5 shown in FIG. 3.

The flange 13 has been integrally formed on the outboard side of the hub (first inside member) 8, wherein the traveling wheel is to be fitted, and the outer periphery of the flange 13 has been formed with the plurality of hub bolt holes 14 disposed at the equal interval in the circumferential direction. Formed further by machining has been the outside-diameter portion (small-diameter stepped portion 15) onto which the inner race element (second inside member) 12 is press-fitted on the inboard side, wherein the driving wheel bearing apparatus 5 of the hub (first inside member) 8 is secured to the car body.

The inner peripheral surface of the axis-directional hole 11 serves as the reference surface for broaching and has been therefore formed by machining, wherein further, as shown in FIG. 12, the inner peripheral portion 31 has been provided with the tapered portion as explained earlier.

In the second assembly process in FIG. 13, the elements configuring the driving wheel bearing apparatus 5 such as the outer race (outer member) 6 having the plurality of outer ring raceways 6a, 6a formed along the inner peripheral surface, the plurality of balls 18 and the cage 19 are fitted to the hub (first inside member) 8, and thereafter the inner race element (second inside member) 12 is press-fitted onto the hub (first inside member) 8.

At this time, however, the interference is provided between the outside-diameter dimension φA of the hub (first inside member) 8 and the inside-diameter dimension φB of the inner race element (second inside member) 12, whereby particularly the inner peripheral portion 31 of the press-fitting portion vicinity 30 of the hub (first inside member) 8 is, as described earlier, reduced in diameter with the result that the inside-diameter dimension of this inner peripheral portion 31 comes to φD′.

This inner peripheral portion 31 is the reference for the broaching to be effected later on, and hence, when the inside-diameter dimension of the inner peripheral portion 31 is reduced down to φD′, the broach as the broaching tool is caught by the diameter-reduced part of the inner peripheral portion 31, with the result that the broaching can not be performed.

Therefore, a contrivance of the third embodiment is that the inside-diameter dimension of the inner peripheral portion 31 of the hub (inner member) 8 is, as illustrated in FIG. 12, previously set larger by +φd into φ(D+d) in a way that takes account of a contraction quantity, whereby the inside-diameter dimension φ(D+d) can be set such as φD′≧φD even when reduced in diameter.

Note that as for the quantity+φd taking account of the contraction quantity produced by the reduction in diameter, the scatter or fluctuation occurs to some extent in the total contraction quantity due to the interference between the outside-diameter dimension φA of the hub (first inside member) 8 and the inside-diameter dimension φB of the inner race element (second inside member) 12, so that a quantity Δα should be added to the quantity φd.

Further, as shown in FIG. 25, the contraction quantity of the inner peripheral portion 31 becomes larger in area closer to the press-fitting portion vicinity 30. Further, not being the uniform deformation, it is desirable that, for example, the dimension and the shape be set to obtain such a tapered shape that the inside-diameter dimension of the inner peripheral portion 31 increases towards the inboard side as shown in FIG. 12. When the inner race element (second inside member) 12 is press-fitted onto this hub (first inside member) 8, it is possible to attain the inner peripheral portion 31 having the inside-diameter dimension φD′ substantially in the uniform cylindrical shape.

Then, as shown in FIG. 15, the inner peripheral portion 31 of the hub (first inside member) 8 and the axis-directional hole 11 are subjected to the broaching on the basis of the inside-diameter dimensions φD′ and φD taking substantially the uniform cylindrical shape, whereby the female serration portion 10 having as accurate dimensional data as causing no deformation by press-fitting.

Further, this technique is carried out in the semi-complete state of the driving wheel bearing apparatus 5, and the broaching needs carrying out by dry working or semi-dry working. Moreover, there may be provided the cover for preventing chips produced when effecting the broaching from entering the interior of the driving wheel bearing apparatus 5.

Next, as shown in FIG. 16, a structure is set so that the preload in the interior of the bearing of the driving wheel bearing apparatus 5 is controlled by plastically deforming a shaft-end portion (inner side end portion 16) of the hub (first inside member) 8 outwards in the radial direction by caulking or clinching.

When effecting the plastically deforming on the inner side end portion 16 of the hub (first inside member) 8 by caulking or clinching, as disclosed in Japan Patent Application Laid-Open No.2002-33995, a configuration may be such that the deformation preventive jig is previously inserted into the inner side end portion 16 of the hub (first inside member) 8, and thereafter the inner side end portion 16 is subjected to the caulking or clinching work, thereby making it possible to prevent the diameter-directional inward deformation of the inner side end portion 16 of the hub (first inside member) 8. In this case, the adverse influence of the caulking or clinching work upon the female serration portion 10 can be further reduced.

This contrivance enables the acquisition of the driving wheel bearing apparatus 5 provided with the female serration portion 10 having the highly accurate dimensional data, and obviates such a problem that the outer joint member 22 of the constant velocity universal joint 21 can not be press-fitted into the female serration portion 10 of the driving wheel bearing apparatus 5.

(Fourth Embodiment)

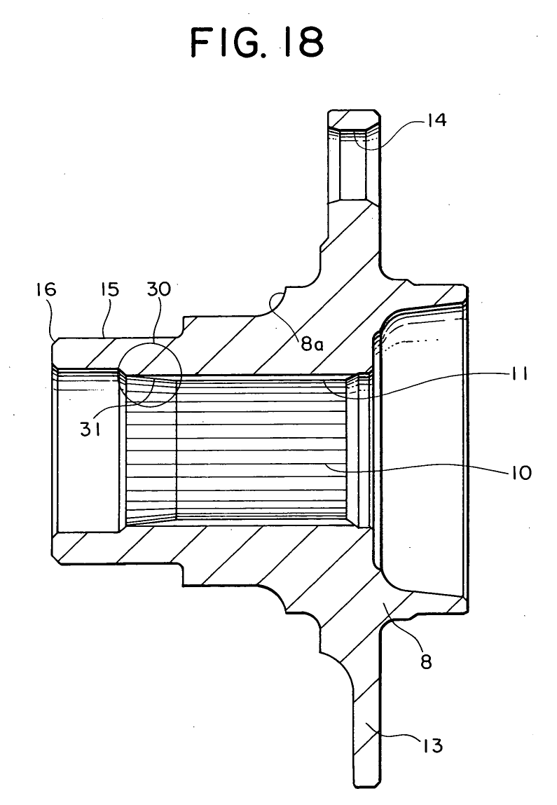

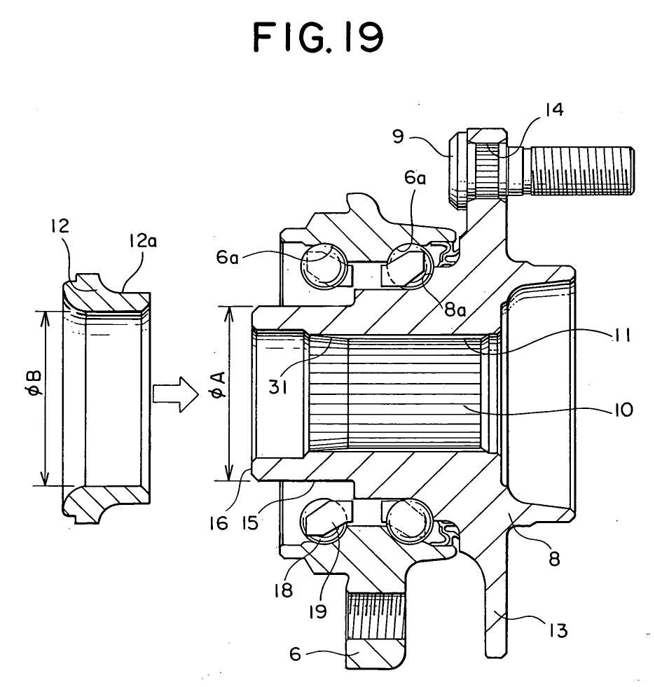

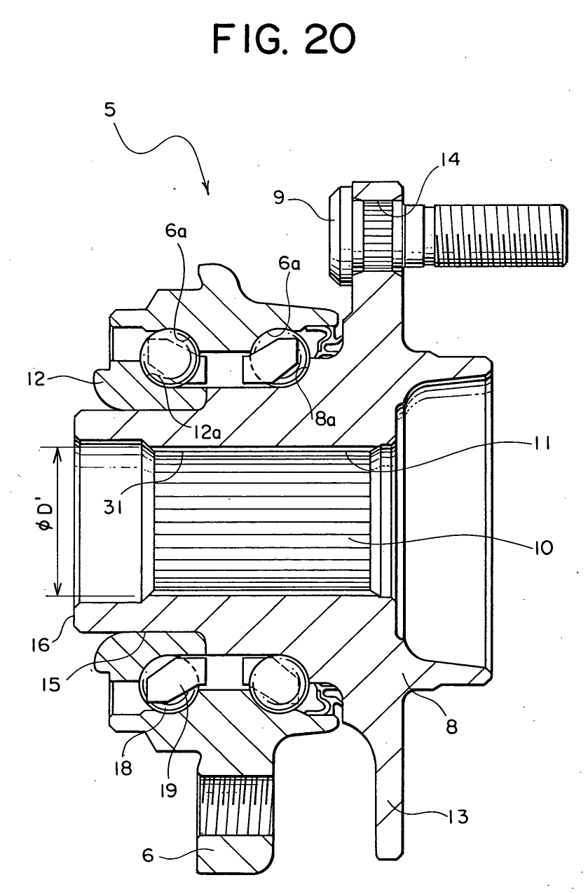

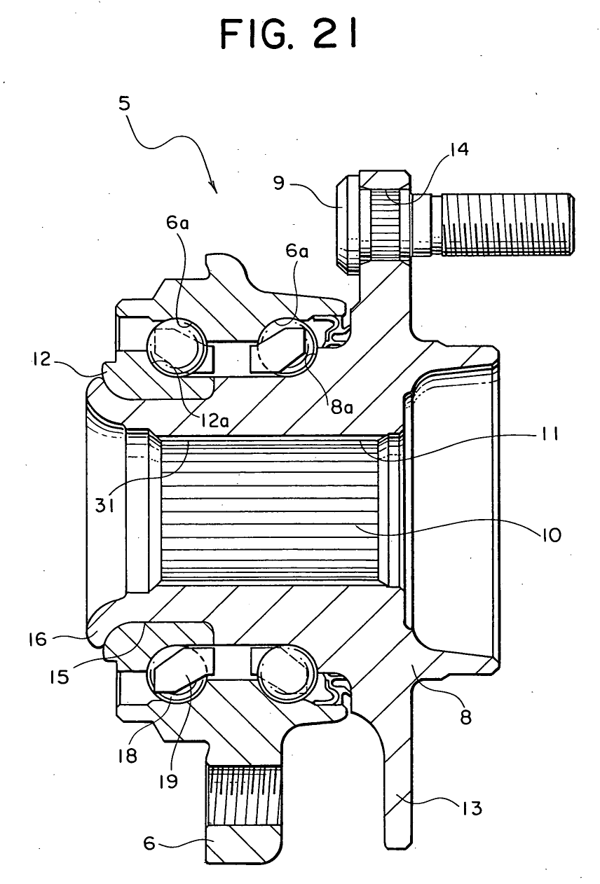

FIG. 17 is a sectional view of the main components of the driving wheel bearing apparatus according to a fourth embodiment of the present invention, showing a first assembly process of the hub unit. FIG. 18 is a sectional view of the main components of the driving wheel bearing apparatus according to the fourth embodiment of the present invention, showing a second assembly process of the hub unit. FIG. 19 is a sectional view of the main components of the driving wheel bearing apparatus according to the fourth embodiment of the present invention, showing a third assembly process of the hub unit. FIG. 20 is a sectional view of the main components of the driving wheel bearing apparatus according to the fourth embodiment of the present invention, showing a fourth assembly process of the hub unit. FIG. 21 is a sectional view of the main components of the driving wheel bearing apparatus according to the fourth embodiment of the present invention, showing a fifth assembly process of the hub unit.

In the first assembly process in FIG. 17, FIG. 17 shows, as a state of a single unit before being assembled, the hub (first inside member) 8 as one element of the driving wheel bearing apparatus 5 in FIG. 3.

The flange 13 has been integrally formed on the outboard side of the hub (first inside member) 8, wherein the traveling wheel is to be fitted, and the outer periphery of the flange 13 has been formed with a plurality of hub bolt holes 14 disposed at the equal interval in the circumferential direction. Formed further by machining has been the outside-diameter portion (small-diameter stepped portion 15) onto which the inner race element (second inside member) 12 is press-fitted on the inboard side, wherein the driving wheel bearing apparatus 5 of the hub (first inside member) 8 is secured to the car body.

Further, after the inner peripheral surface of the axis-directional hole 11, has been formed with the tapered portion as described above as shown in FIG. 17, the female serration portion 10 extending from the flange 13 serving as a hub wheel to the other side end in the axial direction, is previously provided by the broaching in the second assembly process in FIG. 18.

This female serration portion 10 is a portion, wherein the outer joint member 22 of the constant velocity universal joint 21 is press-fitted later on, and the torque is transmitted by meshing of the female serration portion 10 with the toothed portion of the male serration provided on the outer joint member 22 of the constant velocity universal joint 21.

The elements configuring the driving wheel bearing apparatus 5 such as the outer race 6 as the outer member having the plurality of outer ring raceways 6a, 6a formed along the inner periphery, the plurality of balls 18 and the cage 19 are, as shown in FIG. 19, fitted to the hub (first inside member) 8 shown in FIG. 18, and thereafter the inner race element (second inside member) 12 is press-fitted onto the hub (first inside member) 8.

At this time when the inner race element 12 is press-fitted onto the hub (first inside member 8), since the interference is provided between the outside-diameter dimension φA of the hub (first inside member) 8 and the inside-diameter dimension φB of the inner race element (second inside member) 12, particularly the female serration portion 10 of the inner peripheral portion 31 of the press-fitting portion vicinity 30 of the hub (first inside member) 8 is, as described earlier, reduced in diameter.

According to the fourth embodiment, in a state in FIG. 20, on the basis of the small-diameter taking substantially the uniform cylindrical shape, the female serration portion 10 provided beforehand by the broaching in the axis-directional hole 11 of the hub (first inside member) 8 is again subjected to the broaching, whereby the female serration portion 10 having the highly accurate dimensional data can be provided by modifying the overpin diametrical dimension and the large diametrical dimension that have been changed due to the press-fitting.

At this time, the small diametrical dimension may be simultaneously modified depending on the dimensional data of the serration. Further, on the occasion of conducting the broaching once again, the broaching needs effecting in a way that adjusts the broach as the broaching tool to the phase of the female serration portion 10 in FIG. 20. It is preferable that the guide following the female serration portion 10 is provided at the front tooth of the broach on the occasion of performing the broaching once again.

Moreover, this technique is carried out in the semi-complete state of the driving wheel bearing apparatus 5, and the broaching needs carrying out by dry working or semi-dry working. Further, there may be provided the cover for preventing chips produced when effecting the broaching from entering the interior of the driving wheel bearing apparatus 5.

Next, as shown in FIG. 21, a structure is set so that the preload in the interior of the bearing of the driving wheel bearing apparatus 5 is controlled by plastically deforming by caulking or clinching the shaft-end portion (inner side end portion 16) of the hub (first inside member) 8 outwards in the radial direction.

When effecting the plastically deforming on the inner side end portion 16 of the hub (first inside member) 8, as disclosed in Japan Patent Application Laid-Open No.2002-33995, a configuration may be such that the deformation preventive jig is previously inserted into the inner side end portion 16 of the hub (first inside member) 8, and thereafter the inner side end portion 16 is subjected to the caulking or clinching work, thereby making it possible to prevent the diameter-directional inward deformation of the inner side end portion 16 of the hub (first inside member) 8. In this case, the adverse influence of the caulking or clinching work upon the female serration portion 10 can be further reduced.

This contrivance enables the acquisition of the driving wheel bearing apparatus 5 provided with the female serration portion 10 having the highly accurate dimensional data, and obviates such a problem that the outer joint member 22 of the constant velocity universal joint 21 can not be press-fitted into the female serration portion 10 of the driving wheel bearing apparatus 5.

It should be noted that the present invention can be modified in a variety of forms without being limited to the embodiments discussed above.

1. A bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a state where said second inside member is press-fitted onto said first inside member; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member, the inner periphery of said first inside member is subjected to broaching for forming the serration extending in the axial direction, thus acquiring a complete product.

2. A bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a state where said second inside member is press-fitted onto said first inside member; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member subjected to broaching beforehand, the serration extending in the axial direction along the inner periphery of said first inside member is subjected to the broaching once again, thus acquiring a complete product.

3. A bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a non-separable manner at a flange-shaped plastically deformed portion formed by plastically deforming a side end portion of said first inside member towards an outside diameter; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member, the inner periphery of said first inside member is subjected to broaching for forming the serration extending in the axial direction and is subsequently plastically deformed.

4. A bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a non-separable manner at a flange-shaped plastically deformed portion formed by plastically deforming an end portion of said first inside member towards an outside diameter; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member subjected to broaching beforehand, serration extending in the axial direction along the inner periphery of said first inside member is subjected to the broaching once again and the end of said first inside member is subsequently plastically deformed.

5. A driving wheel bearing apparatus according to claim 1, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member into said first inside member.

6. A working method of a bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a state where said second inside member is press-fitted onto said first inside member; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member, the inner periphery of said first inside member is subjected to broaching for forming the serration extending in the axial direction, thus acquiring a complete product.

7. A working method of a bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a state where said second inside member is press-fitted onto said first inside member; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member subjected to broaching beforehand, the serration extending in the axial direction along the inner periphery of said first inside member is subjected to the broaching once again, thus acquiring a complete product.

8. A working method of a bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a non-separable manner at a flange-shaped plastically deformed portion formed by plastically deforming an end portion of said first inside member towards an outside diameter; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member, the inner periphery of said first inside member is subjected to broaching for forming the serration extending in the axial direction and the end portion of said first inside member is subsequently plastically deformed.

9. A working method of a bearing apparatus for a driving wheel comprising:
an outer member having a plurality of outer ring raceways formed along an inner periphery;
an inner member having a plurality of inner ring raceways opposed to said outer ring raceways of said outer member, a first inside member and a second inside member formed with at least one of the plurality of inner ring raceways, said first inside member and said second inside member being joined in a non-separable manner at a flange-shaped plastically deformed portion formed by plastically deforming an end portion of said first inside member towards an outside diameter; and
a plurality of rolling members interposed between said outer member and said inner member,
said bearing apparatus being press-fitted therein with an outer joint member of a constant velocity universal joint through torque transmission means for transmitting torque in such a way that toothed portions of serration of the outer joint member and toothed portions of serration extending along an inner periphery of said first inside member in an axial direction mesh with each other,
wherein after said second inside member has been press-fitted onto said first inside member subjected to broaching beforehand, serration extending in the axial direction along the inner periphery of said first inside member is subjected to the broaching once again and the end portion of said first inside member is subsequently plastically deformed.

10. A working method of a driving wheel bearing apparatus according to claim 6, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member to said first inside member.

11. A driving wheel bearing apparatus according to claim 2, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member into said first inside member.

12. A driving wheel bearing apparatus according to claim 3, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member into said first inside member.

13. A driving wheel bearing apparatus according to claim 4, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member into said first inside member.

14. A working method of a driving wheel bearing apparatus according to claim 7, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member to said first inside member.

15. A working method of a driving wheel bearing apparatus according to claim 8, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member to said first inside member.

16. A working method of a driving wheel bearing apparatus according to claim 9, wherein a preliminary hole formed in said first inside member in order to perform the broaching for forming a toothed portion that transmits a driving force to a traveling wheel has its preliminary hole dimension previously set larger by an amount taking account of a contraction quantity of the preliminary hole dimension that occurs by press-fitting said second inside member to said first inside member.
